(19) United States
(12) Patent Application Publication
(10) Pub. No.: US 2026/0073898 A1
(43) Pub. Date: Mar. 12, 2026

(54) METHOD, APPARATUS, DEVICE AND STORAGE MEDIUM FOR GENERATING MUSIC CONTENT

(71) Applicants: Beijing Zitiao Network Technology Co., Ltd., Beijing (CN); Lemon Inc., Grand Cayman (KY)

(72) Inventors: Shuo ZHANG, Beijing (CN); Dongya Jia, Beijing (CN); Yifeng Yang, Beijing (CN); Weituo Hao, Los Angeles, CA (US); Qingqing Huang, Los Angeles, CA (US); Shouda Liu, Beijing (CN); Jitong Chen, Los Angeles, CA (US)

(21) Appl. No.: 19/320,997

(22) Filed: Sep. 5, 2025

(30) Foreign Application Priority Data
Sep. 6, 2024 (CN) 202411253132.5

(51) Int. Cl. G10H 1/00; G06F 40/284; G06F 40/40

(52) U.S. Cl. CPC G10H 1/0025; G06F 40/284; G06F 40/40; G10H 2210/111

(57) ABSTRACT

Embodiments of the disclosure relate to a method, apparatus, device and storage medium for generating music content. The method provided herein includes: obtaining a set of tokens generated based on input information; providing the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and generating target music content by decoding the plurality of encoded representations.

### CROSS-REFERENCE

The present application claims priority to Chinese Patent Application No. 202411253132.5, filed on Sep. 6, 2024 and entitled “METHOD, APPARATUS, DEVICE AND STORAGE MEDIUM FOR GENERATING MUSIC CONTENT”, which is incorporated herein by reference.

### FIELD

Example embodiments of the present disclosure generally relate to the field of computers, and in particular, to a method, apparatus, device and computer-readable storage medium for generating music content.

### BACKGROUND

With the development of computer technologies, music generation technologies are gradually becoming key technologies in the field of human-computer interaction and digital entertainment. The music generation technology refers to a music creation process in which a machine simulates a human through an algorithm. Accordingly, via the music generation technology, people may create music more conveniently, and even generate music works through simple instructions or text descriptions.

### SUMMARY

In a first aspect of the present disclosure, a method for generating music content is provided. The method includes: obtaining a set of tokens generated based on input information; providing the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and generating target music content by decoding the plurality of encoded representations.

In a second aspect of the present disclosure, there is provided an apparatus for generating music content. The apparatus includes: an obtaining module, configured to obtain a set of tokens generated based on input information; a providing module, configured to provide the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and a generation module, configured to generate target music content by decoding the plurality of encoded representations.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method according to the first aspect.

In a fourth aspect of the present disclosure, a non-transitory computer-readable storage medium is provided. The computer readable storage medium has a computer program stored thereon, and the computer program is executable by a processor to implement the method according to the first aspect.

It should be understood that content described in this content section is not intended to limit key features or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages and aspects of embodiments of the present disclosure will become more apparent with reference to the following detailed description in connection with the accompanying drawings. In the drawings, the same or similar reference numbers denote the same or similar elements, wherein:

FIG. 1 illustrates a schematic diagram of an example system for generating music content according to some embodiments of the present disclosure;

FIG. 2 illustrates a flowchart of an example process of generating music content according to some embodiments of the present disclosure;

FIGS. 3A-3C illustrate schematic diagrams of attention mechanisms according to some embodiments of the present disclosure;

FIG. 4 illustrates a schematic structural block diagram of an apparatus for generating music content according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the disclosure are illustrated in the drawings, it should be understood that the disclosure may be embodied in various forms and should not be construed as limited to the embodiments set forth herein, but rather, these embodiments are provided to provide a more thorough and complete understanding of the disclosure. It should be understood that the drawings and embodiments of the present disclosure are only used for examples, and are not intended to limit the protection scope of the present disclosure.

Note that the headings of any of the sections/subsections provided herein are not limiting. Various embodiments are described herein throughout, and any type of embodiments may be included under any section/subsection. Further, the embodiments described in any section/subsection may be combined in any manner with any other embodiments described in the same section/subsection and/or different sections/sections.

In the description of the embodiments of the present disclosure, the term “including” and similar terms thereof should be understood as open-ended inclusion, that is, “including but not limited to”. The term “based on” should be understood to be “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” etc. may refer to different or identical objects. Other explicit and implicit definitions may also be included below.

As used herein, the term “model” may learn associations between respective inputs and outputs from training data so that corresponding outputs may be generated for a given input after training is completed. The generation of the model may be based on machine learning techniques. Deep learning is a machine learning algorithm that processes inputs and provides corresponding outputs by using multiple layers of processing units. Herein, “model” may also be referred to as a “machine learning model,” a “machine learning network,” or a “network,” these terms are used interchangeably herein. A model may also include different types of processing units or networks.

As used herein, a “unit,” “operating unit,” or “subunit” may consist of a machine learning model or network of any suitable structure. As used herein, a group of elements or similar expressions may include one or more such elements. For example, a “set of convolution units” may include one or more convolution units.

Embodiments of the present disclosure may relate to data of a user, data acquisition and/or use, and the like. These aspects all follow corresponding laws and regulations and related rules. In the embodiments of the present disclosure, the collection, acquisition, processing, manufacturing, forwarding, use and the like of all data are performed on the premise that the user knows and confirms. Accordingly, when implementing the embodiments of the present disclosure, the types, use ranges, use scenarios, and the like of the data or information that may be involved should be notified to the user and authorized by the user in an appropriate manner according to related laws and regulations. The specific notification and/or authorization manner may vary according to actual situations and application scenarios, and the scope of the present disclosure is not limited in this respect.

In the solutions of present specification and the embodiments, if the personal information processing is involved, the processing is performed on the premise of having a legality basis (for example, requesting that a personal information subject agrees, or is necessary for fulfillment of a contract, etc.), and the processing is performed only within a specified or agreed range. A user's rejection of processing personal information other than necessary information required for the basic function, does not affect the use of the basic function by the user.

In the solutions of the present specification and embodiments, if the training and inferencing of a model is involved, the data (including but not limited to data itself, data acquisition and/or use) involved all complies with requirements of corresponding laws and regulations and regulations.

Although some advances have been made in music generation technology, there are still challenges in improving sound quality, generation speed, and generating long audio. A traditional music generation model has limitations in generating high-quality and high-fidelity music segments, and is inefficient when responding and processing long audio data in real time. In addition, generating a long audio work requires that the model can understand and process long-term audio information, which places higher requirements on diversity and richness of training data.

In view of this, embodiments of the present disclosure provide a solution for generating music content. According to this scheme, a set of tokens generated based on input information may be obtained. Further, the set of tokens may be provided to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk. Additionally, the target music content is generated by decoding the plurality of encoded representations.

Thus, embodiments of the present disclosure can generate music content in a streaming manner, thereby supporting partial playing of the music content in the generation process. In addition, the embodiments of the present disclosure can also reduce the dependence on the long audio training data and reduce the cost of data acquisition and training resources.

Various example implementations of this solution are described in detail further below with reference to the accompanying drawings.

### Example System

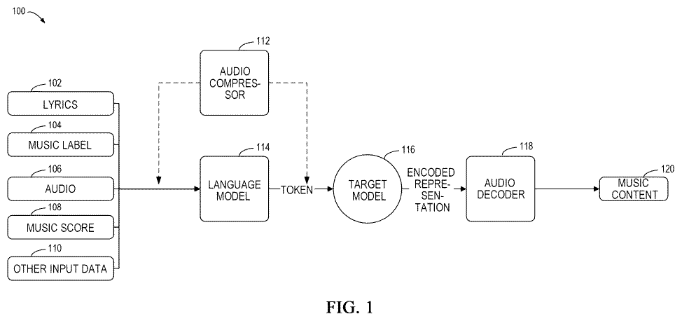

FIG. 1 illustrates a schematic diagram of an example system 100 for generating music content according to some embodiments of the present disclosure. System 100 may be deployed in or implemented with an appropriate electronic device.

In some embodiments, the electronic device may include various types of computing systems/servers capable of providing computing capabilities, and the electronic device may include a terminal device. Such terminal devices may be any type of mobile terminal, fixed terminal, or portable terminal, including mobile phones, desktop computers, laptop computers, notebook computers, netbook computers, tablet computers, media computers, multimedia tablets, personal communication systems (PCS) devices, personal navigation devices, personal digital assistants (PDAs), audio/video players, digital cameras/camcorders, positioning devices, television receivers, radio broadcast receivers, electronic book devices, gaming devices, or any combination of the foregoing, including accessories and peripherals of these devices, or any combination thereof. Electronic devices may include, for example, various types of computing systems/servers capable of providing computing capabilities, such as mainframes, edge computing nodes, computing devices in a cloud environment, virtual machines, and so forth. Although shown as a single device, an electronic device may include multiple physical devices.

As shown in FIG. 1, system 100 may include a language model 114. The language model 114 may obtain various types of input information, such as lyrics 102, a music label 104, audio 106, music score 108, and other input data 110.

In some embodiments, the language model 114 may, for example, process the above input information to generate a set of tokens.

In some embodiments, the system 100 may also include an audio compressor (e.g., audio tokenizer) 112. The audio compressor may, for example, process the audio 106 to generate a set of audio tokens.

In some embodiments, the set of audio tokens may be provided as part of a token sequence input to the target model 116. Alternatively, the set of audio tokens may also be used as input to the language model 114, for example, to generate a token sequence to be provided to the target model 116.

Furthermore, the target model 116 may process the received set of tokens and generate a corresponding encoded representation. In some embodiments, the target model 116 may generate a plurality of encoded representations corresponding to a plurality of chunks, and each chunk may correspond to a predetermined duration, for example.

As an example, the target model 116 may sequentially generate an encoded representation of 0 to 4 seconds, and then generate an encoded representation of 4 to 8 seconds. Furthermore, the system 100 may include an audio decoder 118. The audio decoder 118 may decode the generated encoded representation into a corresponding audio segment and finally obtain the generated music content 120.

In this way, by sequentially generating encoded representations corresponding to a plurality of chunks, the music content 120 may be generated in a streaming manner, thereby improving the generation efficiency of the music content.

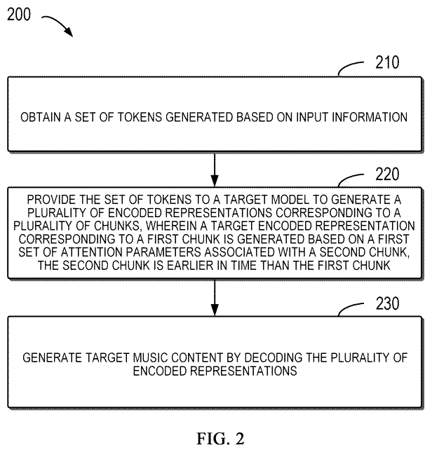

The specific processing process of the target model 116 will be described in detail below with reference to FIG. 2.

### Example Process

FIG. 2 illustrates a flowchart of an example process 200 of generating music content according to some embodiments of the present disclosure. Process 200 may be implemented at system 100. Process 200 is described below with reference to FIG. 1.

As shown in the figure, at block 210, the system 100 obtains a set of tokens generated based on input information.

As discussed with reference to FIG. 1, system 100 may generate an encoded representation corresponding to the audio information with the audio compressor 112, and may generate a set of tokens with the language model 114. Furthermore, the system 110 may provide the set of tokens to the target model 116.

In some embodiments, the target model 116 may include, for example, a diffusion model.

At block 220, the system 100 provides the set of tokens to a target model 114 to generate a plurality of encoded representations corresponding to a plurality of chunks, wherein a target encoded representation corresponding to a first chunk is generated based on a first set of attention parameters associated with a second chunk, the second chunk is earlier in time than the first chunk.

In some embodiments, the target model 114 may generate a corresponding encoded representation according to chunks. For example, the target model 114 may first generate an encoded representation of 0 to 4 seconds and then generate an encoded representation of 4 to 8 seconds.

In some embodiments, the encoded representation of 4 to 8 seconds may be generated based on the encoded representation of 0 to 4 seconds. As will be described in detail below, when generating the encoded representation of 4 to 8 seconds, the target model 114 may determine the attention information of 4 to 8 seconds based on relevant attention parameters of 0 to 4 seconds to generate the encoded representation of 4 to 8 seconds.

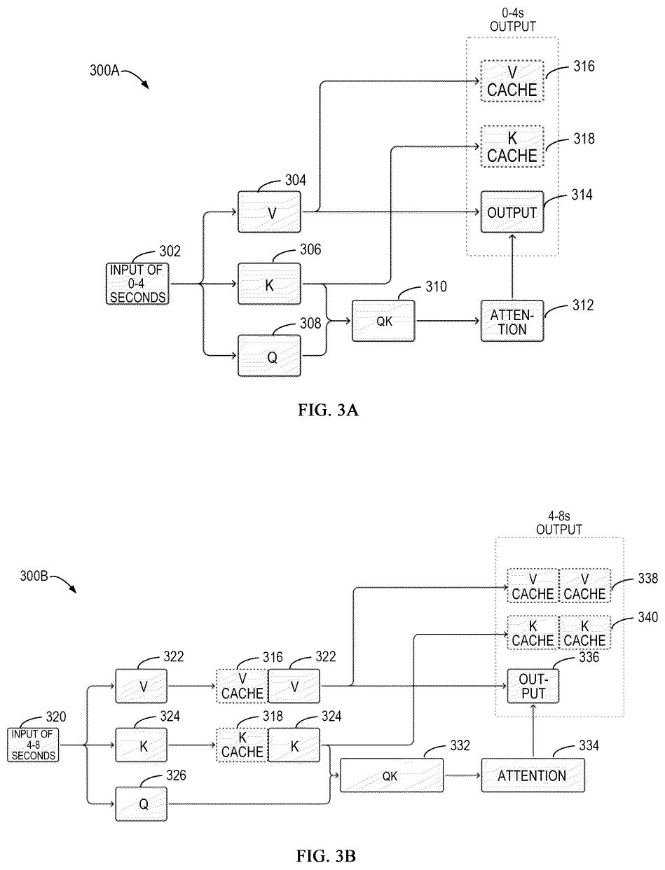

The specific process of block 220 will be described below with reference to FIGS. 3A-3B. FIG. 3A shows a schematic diagram of the target model 114 generating an encoded representation of 0 to 4 seconds (i.e., the second chunk).

As shown in FIG. 3A, the system 100 may obtain an input 302 of 0 to 4 seconds, and may determine a value parameter 304, a key parameter 306, and a query parameter 308 accordingly.

Furthermore, the system 100 may determine a query-key pair 310 and, in turn, determine attention information 312 based on the key parameter 306 and the query parameter 308. Accordingly, system 100 may generate an encoded representation of 0 to 4 seconds, i.e., output 314, based on the value parameter 304 and the attention information 312.

In some embodiments, as shown in FIG. 3A, the system 100 may further write, to a cache module, a set of attention parameters, for example, a cached value parameter 316 and a cached key parameter 318, corresponding to the chunk of 0 to 4 seconds.

FIG. 3B shows a schematic diagram of the target model 114 generating an encoded representation of 4 to 8 seconds (i.e., a first chunk). As shown in FIG. 3B, similar to the process shown in FIG. 3A, the system 100 may obtain an input 320 of 4 to 8 seconds, and accordingly determine a value parameter 322, a key parameter 324, and a query parameter 326 corresponding to the chunk.

Unlike the process shown in FIG. 3A, the system 100 may obtain the cached value parameter 316 and the cached key parameter 318 from the cache module, and update the value parameter 322 and the key parameter 330 corresponding to the first chunk (i.e., 4 to 8 seconds) accordingly.

For example, the system 100 may concatenate the value parameter 316 of 0 to 4 seconds to the value parameter 322 of 4 to 8 seconds to obtain an updated value parameter. Additionally, the system 100 may concatenate the key parameter 318 of 0 to 4 seconds to the key parameter 324 of 4 to 8 seconds to obtain an updated key parameter.

Furthermore, the system 100 may determine the query-key pair 332 based on the updated key parameter and query parameter 326, and accordingly determine attention information 334 corresponding to 4 to 8 seconds.

Furthermore, the system 100 may determine the output 336, i.e., the encoded representation corresponding to 4 to 8 seconds, based on the attention information 334 and the updated value parameter.

Similarly, the system 100 may also write the value parameter and the key parameter corresponding to 4 to 8 seconds into the cache module as the cached value parameter 338 and the cached key parameter 340.

Based on a similar process, during generating the encoded representation of 8 to 12 seconds, the system 100 may also obtain the value parameter of 0 to 4 seconds and the value parameter of 4 to 8 seconds, and the key parameter of 0 to 4 seconds and the key parameter of 4 to 8 seconds in the cache to generate the encoded representation of 8 to 12 seconds.

In this way, embodiments of the present disclosure may realize the generation of encoded representations of chunks based on a local attention mechanism.

With continued reference to FIG. 2, at block 230, the system 100 generates target music content by decoding the plurality of encoded representations.

As an example, the system 100 may decode a plurality of encoded representations to generate target music content with the audio decoder 118. In some embodiments, the target music content may be provided in a streaming manner, for example.

The training process of the target model 116 will be further described below. In some embodiments, the system 100 may train the target model 116 with the training audio content.

In particular, system 100 may determine a reference encoded representation of the training audio content. For example, the system 100 may generate a reference encoded representation of the training audio content with a trained audio encoder.

Furthermore, the system 100 may process a set of training tokens of the training audio content with the target model 116 to generate a training encoded representation. In some embodiments, system 100 may generate encoded representations corresponding to the training audio content with a trained audio compressor 112, and may generate a set of tokens with the language model 114.

Furthermore, the system 100 may provide the set of training tokens to the target model 116 to generate a training encoded representation. Additionally, the system 100 may train the target model 116 based on a difference between the training encoded representation and the reference encoded representation.

For example, the system 100 may adjust parameters of the target model 116 based on a L2 distance of the training encoded representation and the reference encoded representation.

In some embodiments, to support the local attention mechanism of the target model 116, the system 100 may also implement a mask-based attention mechanism in the training process.

Specifically, FIG. 3C shows a schematic diagram of training a target model. As shown in FIG. 3C, during training, the system 100 may similarly determine the value parameter 352, the key parameter 354, and the query parameter 356 based on the input 350.

Additionally, the system 100 may determine the query-key pair 358 based on the key parameter 354 and the query parameter 356. Additionally, the system 100 may determine attention information 360 corresponding to a target chunk to be generated based on the query-key pair 358 and the mask 362.

For example, in the training phase, during generating the encoded representation of 4 to 8 seconds, the mask 362 may indicate determining the attention information 360 based on attention parameters of at least one chunk (e.g., 0 to 4 seconds) associated with the target chunk (4 to 8 seconds). Alternatively, the mask 362 may also indicate determining the attention information 360 based only on the target chunk (4 to 8 seconds) itself.

Similarly, in the training phase, during generating the encoded representation of 8 to 12 seconds, the mask 362 may indicate determining the attention information 360 based on attention parameters of at least one chunks (e.g., 0 to 4 seconds and 4 to 8 seconds) associated with the target chunk (8 to 12 seconds). Alternatively, the mask 362 may indicate determining the attention information 360 based only on the target chunk (8 to 12 seconds) itself.

Therefore, in the training process, the block-shaped mask ensures that the model can only access historical data within a certain time range instead of the entire long audio sequence when calculating the output of the current chunk. This approach reduces the dependence of the model on long audio data during training since even short audio datasets may be used to train the model as long as they can provide sufficient local context information.

Based on the process described above, embodiments of the present disclosure can generate music content in a streaming manner, thereby supporting partial playing of the music content in the generation process. In addition, the embodiments of the present disclosure can also reduce the dependence on the long audio training data and reduce the cost of data acquisition and training resources.

### Example Apparatus and Device

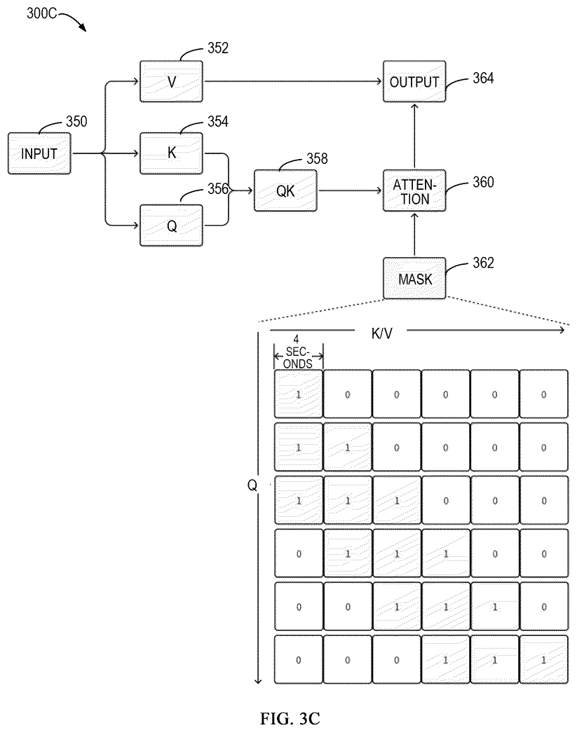

Embodiments of the present disclosure further provide a corresponding apparatus for implementing the above method or process. FIG. 4 shows a schematic structural block diagram of an apparatus 400 for generating music content according to some embodiments of the present disclosure. The apparatus 400 may be implemented as or included in the system 100. The various modules/components in the apparatus 400 may be implemented by hardware, software, firmware, or any combination thereof.

As shown in FIG. 4, the apparatus 400 includes: an obtaining module 410 configured to obtain a set of tokens generated based on input information; a providing module 420 configured to provide the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and a generation module 430 configured to generate target music content by decoding the plurality of encoded representations.

In some embodiments, the obtaining module 410 is further configured to: process at least a portion of the input information with a language model to generate at least a portion of the set of tokens; and/or process audio content of the input information with an audio compressor to generate at least a portion of the set of tokens.

In some embodiments, the apparatus 400 further includes an attention module configured to: during generating an encoded representation of the second chunk, write the first set of attention parameters corresponding to the second chunk into a cache module.

In some embodiments, the attention module is further configured to: during generating the target encoded representation of the first chunk, obtain the first set of attention parameters corresponding to the second chunk from the cache module; update a second set of attention parameters corresponding to the first chunk based on the first set of attention parameters; determine first attention information corresponding to the first chunk based on the updated second set of attention parameters; and generate the target encoded representation based on the first attention information.

In some embodiments, the attention module is further configured to: update the second set of attention parameters by concatenating the first set of attention parameters to the second set of attention parameters.

In some embodiments, the attention module is further configured to: write the second set of attention parameters to the cache module.

In some embodiments, the first set of attention parameters comprises a set of key-value parameters corresponding to the second chunk.

In some embodiments, the target model is trained based on the following process: determining a reference encoded representation of training audio content; processing a set of training tokens of the training audio content with the target model to generate a training encoded representation; and training the target model based on a difference between the reference encoded representation and the training encoded representation.

In some embodiments, processing the set of training tokens of the training audio content with the target model comprises: determining a target mask corresponding to a target chunk; determining second attention information corresponding to the target chunk based on the target mask; and generating a target training encoded representation corresponding to the target chunk based on the second attention information.

In some embodiments, the target mask indicates determining the second attention information based on an attention parameter of at least one chunk associated with the target chunk, wherein the at least one chunk is earlier in time than the target chunk.

In some embodiments, the target model comprises a diffusion model.

The modules included in the apparatus 400 may be implemented in various manners, including software, hardware, firmware, or any combination thereof. In some embodiments, one or more units may be implemented using software and/or firmware, such as machine-executable instructions stored on a storage medium. Some or all of the modules in the apparatus 400 may be implemented, at least in part, by one or more hardware logic components in addition to or as an alternative to machine executable instructions. By way of example, and not limitation, illustrative types of hardware logic components that may be used include field-programmable gate arrays (FPGAs), application-specific integrated circuits (ASICs), application-specific standards (ASSPs), system-on-a-chip (SOCs), complex programmable logic devices (CPLDs), and the like.

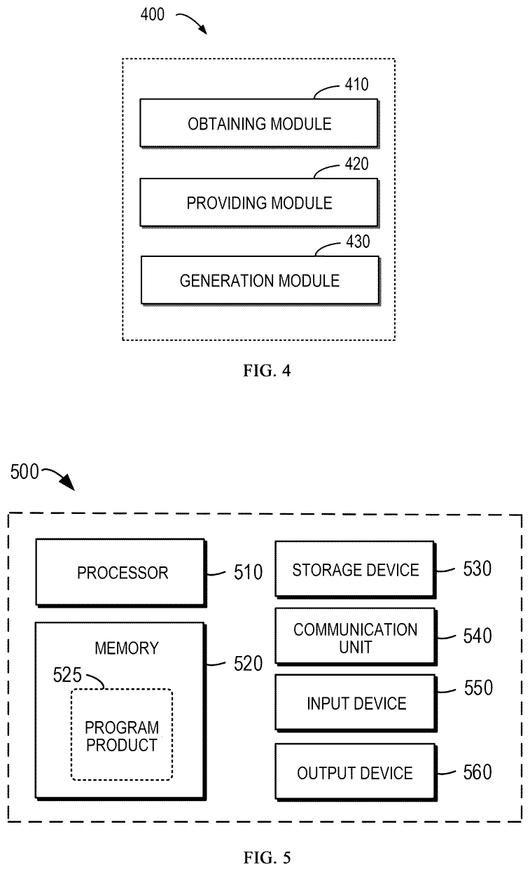

FIG. 5 illustrates a block diagram of an electronic device 500 in which one or more embodiments of the present disclosure may be implemented. It should be understood that the electronic device 500 shown in FIG. 5 is merely illustrative and should not constitute any limitation on the function and scope of the embodiments described herein. The electronic device 500 shown in FIG. 5 may be used to implement the system 100 of FIG. 1.

As shown in FIG. 5, the electronic device 500 is in the form of a general-purpose electronic device. Components of electronic device 500 may include, but are not limited to, one or more processors or processing units 510, memory 520, storage device 530, one or more communication units 540, one or more input devices 550, and one or more output devices 560. The processing unit 510 may be an actual or virtual processor and can perform various processes according to programs stored in the memory 520. In a multi-processor system, multiple processing units execute computer-executable instructions in parallel to improve the parallel processing capability of the electronic device 500.

The electronic device 500 typically includes a plurality of computer storage media. Such media may be any available media accessible to the electronic device 500, including but not limited to volatile and non-volatile media, removable and non-removable media. The memory 520 may be volatile memory (e.g., registers, cache, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, a magnetic disk, or any other medium, which may be capable of storing information and/or data and which may be accessed within electronic device 500.

The electronic device 500 may further include additional removable/non-removable, volatile/non-volatile storage media. Although not shown in FIG. 5, a magnetic disk drive for reading from or writing to a removable, non-volatile magnetic disk (e.g., a “floppy disk”) and an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to perform various methods or acts of various embodiments of the present disclosure.

The communication unit 540 communicates with other electronic devices through a communication medium. Additionally, the functionality of the components of the electronic device 500 may be implemented in a single computing cluster or multiple computing machines capable of communicating over a communication connection. Thus, electronic device 500 may operate in a networked environment using logical connections to one or more other servers, network personal computers (PCs), or another network node.

Input device 550 may be one or more input devices, such as a mouse, keyboard, trackball, or the like. The output devices 560 may be one or more output devices, such as monitors, speakers, printers, and the like. The electronic device 500 may also communicate with one or more external devices (not shown) through the communication unit 540 as needed, such as a storage device, a display device, etc., with one or more devices that enable a user to interact with the electronic device 500, or with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, there is further provided a computer program product tangibly stored on a non-transitory computer readable medium and including computer executable instructions which are executed by a processor to implement the method described above.

Various aspects of the disclosure are described herein with reference to flowcharts and/or block diagrams of methods, apparatuses, devices, and computer program products implemented according to the disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce means for implementing the functions/acts specified in one or more blocks of the flowchart and/or block diagram. These computer-readable program instructions may also be stored in a computer-readable storage medium that causes a computer, programmable data processing apparatus, and/or other devices to function in a particular manner, such that the computer-readable medium having instructions stored thereon includes an article of manufacture including instructions that implement various aspects of the functions/acts specified in one or more blocks the flowchart and/or block diagram.

Computer-readable program instructions may be loaded onto a computer, other programmable data processing apparatus, or other device such that a series of operational steps are performed on the computer, other programmable data processing apparatus, or other device to produce a computer-implemented process such that the instructions that execute on the computer, other programmable data processing apparatus, or other device implement the functions/acts specified in one or more blocks of the flowchart and/or block diagram.

The flowcharts and block diagrams in the figures illustrate the architecture, functionality, and operation of possible implementations of systems, methods, and computer program products according to various implementations of the present disclosure. In this regard, each block in a flowchart or block diagram may represent a module, a program segment, or a portion of an instruction that contains one or more executable instructions for implementing specified logical functions. In some alternative implementations, the functions noted in the blocks may also occur in a different order than those noted in the figures. For example, two consecutive blocks may actually be executed substantially in parallel, or they may sometimes be executed in reverse order, depending on the functionality involved. It is also noted that each block in the block diagrams and/or flowcharts, and combinations of blocks in the block diagrams and/or flowcharts, may be implemented with a dedicated hardware-based system that performs the specified functions or acts, or may be implemented with a combination of dedicated hardware and computer instructions.

Implementations of the present disclosure have been described above, and the above description is illustrative, not exhaustive, and is not limited to the disclosed implementations. Many modifications and alterations will be apparent to those of ordinary skill in the art without departing from the scope of the illustrated implementations. The selection of terms as used herein is intended to best explain the principles of various implementations, practical applications or improvements to technology in the market, or to enable others of ordinary skill in the art to understand various implementations disclosed herein.

1. A method for generating music content, comprising:
obtaining a set of tokens generated based on input information;
providing the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and
generating target music content by decoding the plurality of encoded representations.

2. The method of claim 1, wherein obtaining the set of tokens generated based on the input information comprises at least one of:
processing at least a portion of the input information with a language model to generate at least a portion of the set of tokens; or
processing audio content of the input information with an audio compressor to generate at least a portion of the set of tokens.

3. The method of claim 1, further comprising:
during generating an encoded representation of the second chunk, writing the first set of attention parameters corresponding to the second chunk into a cache module.

4. The method of claim 3, further comprising:
during generating the target encoded representation of the first chunk, obtaining the first set of attention parameters corresponding to the second chunk from the cache module;
updating a second set of attention parameters corresponding to the first chunk based on the first set of attention parameters;
determining first attention information corresponding to the first chunk based on the updated second set of attention parameters; and
generating the target encoded representation based on the first attention information.

5. The method of claim 4, wherein updating the second set of attention parameters corresponding to the first chunk based on the first set of attention parameters comprises:
updating the second set of attention parameters by concatenating the first set of attention parameters to the second set of attention parameters.

6. The method of claim 4, further comprising:
writing the second set of attention parameters to the cache module.

7. The method of claim 1, wherein the first set of attention parameters comprises a set of key-value parameters corresponding to the second chunk.

8. The method of claim 1, wherein the target model is trained based on the following process:
determining a reference encoded representation of training audio content;
processing a set of training tokens of the training audio content with the target model to generate a training encoded representation; and
training the target model based on a difference between the reference encoded representation and the training encoded representation.

9. The method of claim 8, wherein processing the set of training tokens of the training audio content with the target model comprises:
determining a target mask corresponding to a target chunk;
determining second attention information corresponding to the target chunk based on the target mask; and
generating a target training encoded representation corresponding to the target chunk based on the second attention information.

10. The method of claim 9, wherein the target mask indicates determining the second attention information based on an attention parameter of at least one chunk associated with the target chunk, wherein the at least one chunk is earlier in time than the target chunk.

11. The method of claim 1, wherein the target model comprises a diffusion model.

12. An electronic device, comprsing:
at least one processor; and
at least one memory coupled to the at least one processor and storing instructions for execution by the at least one processor, wherein the instructions, when executed by the at least one processor, cause the electronic device to perform acts comprising:
obtaining a set of tokens generated based on input information;
providing the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and
generating target music content by decoding the plurality of encoded representations.

13. The electronic device of claim 12, wherein obtaining the set of tokens generated based on the input information comprises at least one of:
processing at least a portion of the input information with a language model to generate at least a portion of the set of tokens; or
processing audio content of the input information with an audio compressor to generate at least a portion of the set of tokens.

14. The electronic device of claim 12, wherein the acts further comprise:
during generating an encoded representation of the second chunk, writing the first set of attention parameters corresponding to the second chunk into a cache module.

15. The electronic device of claim 14, wherein the acts further comprise:
during generating the target encoded representation of the first chunk, obtaining the first set of attention parameters corresponding to the second chunk from the cache module;
updating a second set of attention parameters corresponding to the first chunk based on the first set of attention parameters;
determining first attention information corresponding to the first chunk based on the updated second set of attention parameters; and
generating the target encoded representation based on the first attention information.

16. The electronic device of claim 15, wherein updating the second set of attention parameters corresponding to the first chunk based on the first set of attention parameters comprises:
updating the second set of attention parameters by concatenating the first set of attention parameters to the second set of attention parameters.

17. The electronic device of claim 15, wherein the acts further comprise:
writing the second set of attention parameters to the cache module.

18. The electronic device of claim 12, wherein the first set of attention parameters comprises a set of key-value parameters corresponding to the second chunk.

19. The electronic device of claim 12, wherein the target model is trained based on the following process:
determining a reference encoded representation of training audio content;
processing a set of training tokens of the training audio content with the target model to generate a training encoded representation; and
training the target model based on a difference between the reference encoded representation and the training encoded representation.

20. A non-transitory computer-readable storage medium having a computer program stored thereon, wherein the computer program is executable by a processor to implement acts comprising:
obtaining a set of tokens generated based on input information;
providing the set of tokens to a target model to generate a plurality of encoded representations corresponding to a plurality of chunks, wherein a target encoded representation corresponding to a first chunk is generated based on a first set of attention parameters associated with a second chunk, the second chunk is earlier in time than the first chunk; and
generating target music content by decoding the plurality of encoded representations.
